(19) United States
(12) Patent Application Publication
(10) Pub. No.: US 2011/0119233 A1
(43) Pub. Date: May 19, 2011

(54) SYSTEM, METHOD AND COMPUTER PROGRAM FOR SYNCHRONIZING DATA BETWEEN DATA MANAGEMENT APPLICATIONS

(76) Inventor: Raymond Reddy, Mississauga (CA)

(21) Appl. No.: 13/003,898

(22) PCT Filed: Aug. 20, 2009
(86) PCT No.: PCT/CA2009/001174

§ 371 Date: Jan. 13, 2011

Related U.S. Application Data
(60) Provisional application No. 61/080,815, filed on Jul. 15, 2008.

(51) Int. Cl. G06F 17/30

(52) U.S. Cl. 707/624; 707/E17.005

(57) ABSTRACT

A system, method, and computer program for synchronizing of the state of a data management application and data items within or accessible by the data management applications is provided. The data items are managed on a plurality of devices using a plurality of data management applications. Additions, modifications, or deletions made using any of the data management applications can be synchronized in any direction to the other data management applications. A synchronization utility defines common schemas to manage synchronization between the data management applications, which may each store similar or dissimilar information relating to the data items.

### FIELD OF THE INVENTION

The present invention relates to synchronization of data between data management applications. The present invention more specifically relates to automatic synchronization of data between data management applications located on remote networked computers.

### BACKGROUND TO THE INVENTION

With the proliferation of networked computers, a large number of people have collections of media content (including but not limited to photos, audio, video, pictures and documents) spread between multiple networked computers, such as a home personal computer and a work laptop. Each of these networked computers can be used independently for managing media collections (with features including modifying, adding or deleting media content, and of associating attributes with the media content using, for example, metadata), enabling consumption of content (playback of audio or video, viewing pictures etc.), and, optionally, selecting media content to load on an associated portable device.

The problem that has arisen is that users are now presented with multiple networked computers and portable devices, each potentially with a different media management application, and each containing media content collections which are managed independently. Present media management applications suffer in at least two respects. Firstly, most media management applications are not able to exchange data between instances, whether running on the same computing device or remote computing device—for example Apple™ iTunes™ running on a home PC and Apple™ iTunes™ running on a work laptop.

Further, data and attributes stored in media management utilities are not necessarily standardized in a way that data associated with the media can be shared between dissimilar products, for example products developed by different vendors such as Apple™ iTunes™ and WINDOWS™ MEDIA PLAYER™. Each of these applications provides different feature sets and capabilities or implements similar features in different ways. For example, one may only be able to manage audio content while another may be able to further manage photos and videos or they might support different codecs for audio playback.

Many users desire a unified content collection present on all networked computers they own, such that new content acquired or management actions performed on one networked computer or using one application are automatically available or reflected on a second networked computer or a second application. Although synchronization products currently exist to synchronize media content between multiple devices, these products typically require users to undergo a difficult and time-consuming manual process. In this regard, it has thus far been challenging to provide a user with a fully automated product to synchronize media content and associated data between these dissimilar applications, whether on the same device or on separate networked computers.

Furthermore, people have increasingly begun to use web based media management applications to manage a part or all of their media collection. This is especially popular for managing media content that is then accessible from a remote networked computer. An example of such a media management application is Flickr.com™ by Yahoo™.

Increasingly, media management applications operate on portable devices, including mobile phones. These devices are typically smaller and have fewer resources (e.g. storage capacity) than comparable networked computers. Further, these devices may not have the capability to establish network connections or may have a wireless network connection with only sporadic data connectivity. Conventionally if a user's media content collection does not fit on a portable device, the user is required to select a subset of media content and transfer only the subset to the portable device.

Furthermore, valuable data stored in media management applications may be lost when a user attempts to manually exchange data between two media management applications. For example Apple™ iTunes™ stores a ‘User Rating’ and ‘Played Count’ for each song in a media collection that reflect how much a user likes a particular song and the number of times the song was played respectively. This allows users to quickly search for their favourite songs or the songs they like listening to the most. When a user attempts to manually copy their music collection between one computer and another that data is not transferred which is clearly disadvantageous.

Further still, there have not been any solutions proposed for synchronizing the use or state of media management applications, for example the currently playing song or volume setting.

As portable devices become more sophisticated and ‘converged devices’ such as the APPLE™ iPhone™ become available, media management applications on portable devices are increasingly more capable and start resembling media management applications available on networked computer devices, such as Apple™ iTunes™ and WINDOWS™ MEDIA PLAYER™. Some such media management applications allow for more complete management capability of a person's media content collections from a portable device such as the converged devices referred to above, however there may be increasing dissimilarity between them, such as storage capacity and data bandwidth limitations. As such, simple synchronization of data between the computer device and the portable device is not possible since the portable device may not have sufficient capacity or may not support certain functions.

Thus, there is a need for technology that enables complete synchronization of a media content collection and media management applications in all directions between multiple networked computers and portable devices, which includes synchronization of media content, related attributes and the current or active state of the media management application such that all modifications made to media content, related attributes and the state of the application on any of the networked computers or portable devices is reflected on all of the other networked computers and portable devices. There is a further need for such a technology that achieves synchronization automatically and thereby enables management of a user's media content collection between all networked computers and portable devices, and all media management applications even if they implement different feature sets, or the same features in different ways.

### SUMMARY OF THE INVENTION

The present invention provides a system for synchronizing one or more data items between a plurality of data management applications, the system comprising: (a) a plurality of data management applications, implementable to a plurality of interconnectable computers, each data management application being associated with or operable to access one or more content, wherein associated with the one or more content is one or more attributes, wherein at least one data management application manages the one or more attributes differently than at least one other data management application; (b) one or more application connectors, each of the plurality of data management applications being linked to an application connector or including an application connector, each application connector being operable to (i) translate one or more data layers of the one or more attributes to conform to a common schema thereby defining common schema information, and (ii) enable the translation of the common schema information to provide one or more updated data layers of the one or more attributes conforming to at least one of the data management applications; and (c) at least one synchronization utility linked to the one or more application connectors, operable to synchronize one or more layer of content or one or more attributes, including one or more specific data layers of such content or one or more attributes, between two or more data management applications.

The present invention also provides a system for synchronizing one or more data items between a plurality of data management applications, the system comprising a synchronization means, implemented to a computer so as to enable synchronization of one or more of content, application data and configuration data, as between the plurality of data management applications, the plurality of data management applications being implemented to one or more interconnectable computers; wherein each data management application is associated with or operable to access the one or more content, wherein associated with the one or more content is application data, wherein at least one data management application manages the application data and configuration data differently than at least one other data management application; wherein the synchronization means is operable to enable synchronization of one or more of content, application data and configuration data between two or more data management applications by: (1) translating or facilitating the translation of one or more of content, application data or configuration data to conform to a common schema thereby defining common schema information for one or more data management applications; and (2) translating or facilitating the translation of common schema information to updated content or application data for one or more other data management applications so as to initiate updates thereof for the at least one other data management application.

The present invention further provides a computer-implementable method for synchronizing one or more data items, the method comprising: in relation to at least one data management application and at least one other data management application, wherein each data management application is associated with or operable to access one or more of content, application data and configuration data, wherein at least one data management application manages one or more of application data and configuration data differently from at least one other data management application; synchronizing one or more of content, application data and configuration data between the at least one data management application and the at least one other data management application by: (1) translating, or facilitating the translation, by one or more computer processors, the one or more of content, application data and configuration data to conform to a common schema thereby defining common schema information; (2) translating or facilitating the translation of common schema information to one or more of updated content, application data and configuration data for the other data management applications so as to initiate updates thereof for the at least one other data management application.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 illustrates a plurality of data layers stored in a typical media management application operating on a personal computer.

FIG. 2 illustrates a data stack hierarchy for synchronizing data between data management applications operating on separate networked computers.

FIG. 3 illustrates a system implementation of the present invention.

FIG. 4 illustrates an architecture diagram of a system of the present invention.

FIG. 5 illustrates the process of synchronization in accordance with the present invention wherein the data management application is a media management application and the application connector is a media management agent.

FIG. 6 illustrates flow diagrams relating to synchronization processes in accordance with the present invention.

FIG. 7 illustrates the synchronization process of the present invention, wherein synchronization occurs between networked computers with data management applications.

FIG. 8 illustrates a method of mapping and translating application data in accordance with the present invention.

FIG. 9 illustrates an example of schema mappings for a subset of metadata for media items between two particular media management applications.

FIG. 10 illustrates an example of schema mappings for a subset of collection data pertaining to playlists between two particular media management applications.

FIG. 11 illustrates a first example media management application wherein the content are images.

FIG. 12 illustrates a second example media management application wherein the content are images.

FIG. 13 illustrates a configuration data translation schema for translating certain configuration data for two particular media management applications.

### DETAILED DESCRIPTION

### Overview

The present invention enables the synchronization of a plurality of data items between one or more data management applications by the dissemination of common schema information.

The present invention provides a system, method and computer program for synchronizing a plurality of data items across one or more data management applications. The plurality of data items, also referred to herein as a data collection, may be managed by the plurality of data management applications, which may be, for example, software applications or operating systems. Each data item may be characterised by content and one or more attributes associated with the content. Each of the plurality of data management applications may be operable to manage the one or more attributes for each data item differently from other data management applications.

The data management applications are further associated with an application connector that is operable to receive information from the data management applications relating to additions, modifications, or deletions to the data items, and translate the additions, modifications, or deletions to common schema information conforming to a common schema representing content and attributes of the data items.

At least one synchronization utility may be associated with the application connectors. Each synchronization utility may be operable to receive the common schema information from one or more of its associated application connectors, and disseminate the common schema information to its other associated application connectors. The plurality of application connectors may be further operable to receive the common schema information from the at least one synchronization utility and act on the common schema information by initiating one or more updates of the data items associated with the data management applications associated with the application connectors.

The present invention also discloses a system, method and computer program for synchronizing data between a plurality of data management applications distributed on one networked computer, one portable device, or between one or more networked computers or portable devices. Each data management application indexes or is linked to a plurality of data items, which each comprise content and one or more attributes associated with the content. An adaptive data layer synchronization model is provided for analyzing the data and separating it into one or more data layers that can be synchronized independently between data management applications without the need to synchronize all data layers at all times.

The present invention also defines a common schema that provides for a mapping and, optionally, translation of one or more attributes of a data item, wherein the attributes are associated with content of the data item so that any modified attributes can be synchronized between similar or dissimilar products such as data management applications. The data item and attributes may be categorized by one or more data layers.

The system of the present invention may be provided on a distributed and networked basis. For example, one or more of the data management applications may be on physically separated computers, and the synchronization utility may be on yet another computer (such as a server). Using networking means, the synchronization utility may interface with each of the data management applications using application connectors that could be on the server, on the computers for their associated data management applications, or on yet further computers.

It should be noted that the networked computers may be hand-held two-way wireless paging computers, wirelessly enabled palm-top computers, mobile telephones with data messaging capabilities, portable digital media players with wireless or wired synchronization means, network enabled laptop computers, or any type of mobile data communication device capable of sending and receiving messages via a wireless or wired network connection, or could be desktop computers, local servers, internet servers, a cluster of computers, which may be desktop computers, mobile devices, automobiles having wired or wireless network connectivity or any other device operable to store a collection of data items so long as the networked computer is a network connected device operable to synchronize with another network connected device.

In order to aid in the understanding of the following, and without limiting the generality of the present invention, the following description uses a media management application as an example implementation of the data management application and a media file as an example of data item. A person skilled in the art will understand that the present invention could apply to other implementations, for example with different types of content or associated attributes from what is described below. Alternate examples include a plurality of customer relationship management applications or enterprise financial applications created by different software vendors (for example, by Microsoft, SAP and Oracle).

### Data Layers Related to Media

The present invention provides a system and method for synchronizing a plurality of data items between one or more data management applications. One example of a type of data item is media. Data items that are media items may include a variety of types of media that belong to a particular media collection including images, audio and video items. Each media item may include content and one or more attributes. A data management application for media items may be a media management application operating on one or more computers. Again, it should be understood that the data item need not be a media item, which is referred to solely to aid in the understanding of the invention.

The media management application may comprise a data store, or be linked to a database, for storing content and one or more attributes. The data items may be digital data associated with audio, video, text and/or images that can be listened to or viewed by a user. Some examples of specific forms of content for media items include songs, albums, electronic books and magazines (or chapters or articles therefrom), audiobooks, movies, television episodes, music videos, photos, computer games, audio and/or video clips, presentations, news reports, sports updates, and podcasts.

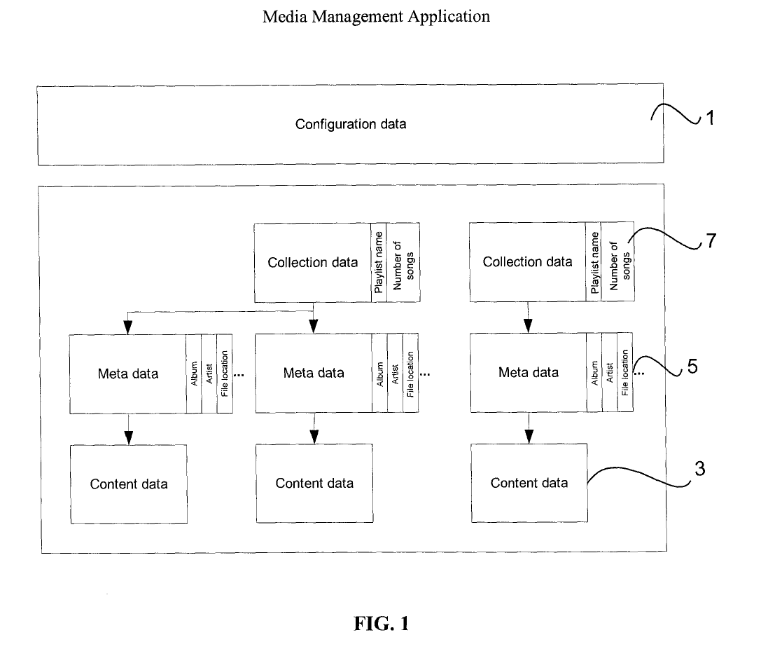

FIG. 1 illustrates the different data layers that make up a collection of data items within a data management application. In the example provided, the data is digital media. Content 3 defines a first layer of a data item and typically the storage space required to store the content is several orders of magnitude greater than the storage space required to store attributes associated with the data item. In the context of a media item, content 3 is a digital media file such as the audio data of a song or the video data in a movie. The one or more attributes describing a data item may comprise metadata 5, collection data 7 and configuration data 1.

Metadata 5 defines a second attribute layer, comprising data describing the associated content. Metadata may be, for example, obtained from the data management application or from the data item itself. In the context of a media item that is a song, metadata may include the song title, album, artist, genre, user ratings and file location (i.e. a pointer to the location of content on a data storage medium). In the case of a media item that is an image, metadata may include the album, date it was taken and a user caption. In the case of a media item that is a television episode video, metadata may include the series title, season, episode title and episode number.

Collection data 7 defines a third attribute layer, comprising data describing a data collection. Collection data can, for example, define a data collection based on metadata. For example, a data collection may be based on data items having an item of metadata identical to a particular value. In the context of media items, for example, the value could be a particular playlist, artist or album (for audio) or a vacation title (for images that are photos). The corresponding media collection would be defined by all media items having metadata with an equal value to the particular value. Alternatively, a media collection could be user defined, for example in the form of a playlist of favourite songs, a slideshow of pictures, etc. These media collections may not be based on values of metadata but instead may be defined using pointers or other references to particular media items.

The particular collection data, for an identical data collection available to each data management application may differ based on the functionality of each media management application. For example a particular media management application may store a certain attribute of metadata for an audio file (such as the bit rate) whereas another particular media management application may not. The collection data as a whole, therefore, may include all possible collection data between all media management applications with which the media item is known to be associated.

Particular types of attributes may be associated with particular types of data management applications. Each type of data management application may be linked to a further series of attributes relating to the use or state of that data management application with the particular data items or collection of data items. These attributes may be considered configuration data, which defines a fourth layer. One example of configuration data is for data describing the “state” of a data management application for consuming a particular data item. In the context of a media management application this could include, for example, the currently playing song within a playlist and volume setting or the zoom-level view for a picture. Certain types of configuration data could be proprietary to certain media management applications and others types could be commonly shared between media management applications. For example, one media management application could enable configuration of an equalizer and another may not, while both media management applications may enable configuration of a volume setting. An example is also given under the heading “Translating Configuration Data” below in relation to FIG. 15.

Metadata 5, collection data 7 and configuration data 1 are stored within or are accessible through the data management application and in certain instances particular metadata 5, collection data 7 and configuration data 1 may be specific to a particular data management application. As such, metadata 5, collection data 7 and configuration data 1 can be jointly referred to as application data. In certain cases, particular metadata may be stored in a file and may need to be accessed directly from the file instead of through the data management application. For the sake of simplicity in the understanding of the present invention, such metadata 5 is still referenced under application data. Application data thus defines the content, related attributes and current state or settings of a media management application.

It should be readily apparent to those skilled in the art that the definitions of content, metadata, collection data, configuration data and application data may be extended to other kinds of data management applications. For example, the data management applications may be enterprise CRM applications such as SAP™ or SALESFORCE.COM™. Since these applications are large they may include sub-categories such as a market analytics component. The content 3 might contain detailed analytic data in the form of reports configurable to provide graphs. Metadata 5 may represent details on each type of report such as the customer name, market segment or account manager as well as a summary or abstract of the report. The collection data 7 may represent analytic reports grouped by various collections such as by industry segment or account representative. The configuration data 1 may contain user preferences on kinds of graph formats or dashboard visualizations. Application data can refer to metadata, collection data and configuration data collectively thus capturing the attributes related to content and state or settings of the data management application such as a CRM application.

### Adaptive Data Layer Synchronization

While the prior art is focused on synchronization of content between networked computers, the present invention enables the synchronization of data items between data management utilities, including some or all content and one or more layers of application data, based on data layers, utilizing the capabilities of each networked computer on which each data management application operates. The present invention accomplishes this using a novel and superior two-way adaptive data layer synchronization model that is able to synchronize each data layer independently.

The adaptive data layer synchronization model enables the data items contained within or referenced by a data management application to be analyzed and separated into one or more data layers that can be synchronized independently between data management applications without the need to synchronize all data layers at all times. The data layers may be as described above, comprising content, metadata, collection data and configuration data.

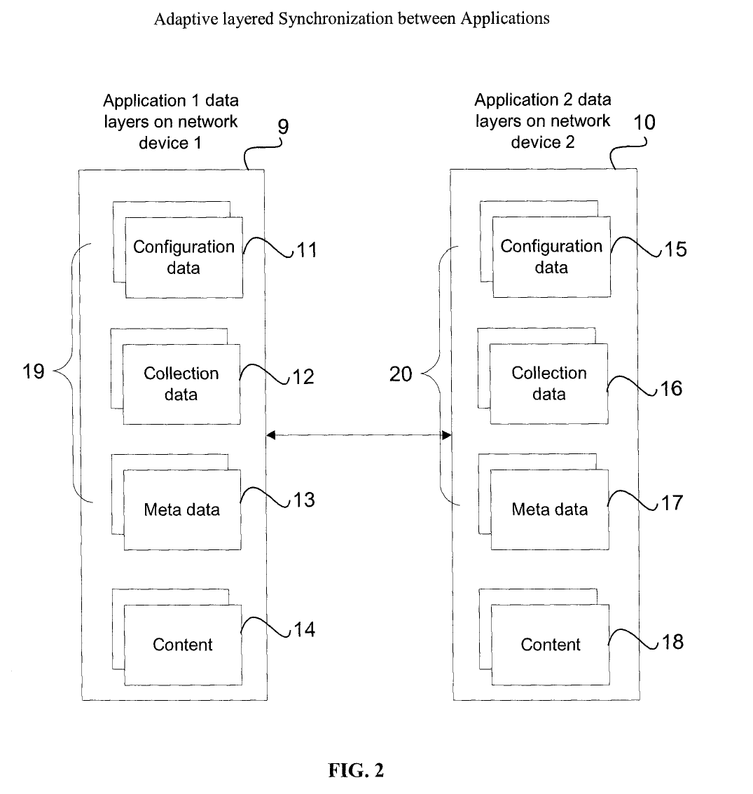

The adaptive data layer synchronization model enables synchronization of content and application data by synchronizing one or more data layers independently from other data layers. Only those data layers that are previously unsynchronized need be synchronized, rather than requiring synchronization of all layers of data items. FIG. 2 illustrates the separation of data layers in a collection of data items within applications 9 and 10 operating on separate networked computers.

The present invention enables synchronization of data layers across data management applications 9, 10 shown in FIG. 2. The present invention enables synchronization of combinations of data layers so that one or more data layers 11, 12, 13, 14 of one application 9 are synchronized with one or more corresponding data layers 15, 16, 17, 18 of another application 10. In one example, only content 14, 18 are synchronized between applications 9, 10. This may be desired where, for example, application 10 operates on a portable device having no display, in which case it is optimal to synchronize only content 14, 18 and forego synchronization of all application data 19, 20. In another example only application data 19, 20 are synchronized between applications 9, 10, which may be desired where application 10 operates on a portable device that is used to remotely control a desktop computer. In this case application 10 does not itself require access to or storage of content 18 since it is used as a remote control and is only capable of displaying application data 19 and not capable of playing back content 18. It should be understood to those skilled in the art that, based on these examples, further combinations of synchronization are possible.

In another example, still referring to FIG. 2, the present invention enables a user to synchronize a file system 9 of a first networked computer with a file system 10 on a second networked computer, for example enabling synchronization of a desktop computer file system with a portable device. The configuration data 11, 15 may represent the user's setting and preferences with regards to viewing files such as showing large or small icons, showing/hiding file extensions and showing/hiding system files. The metadata 13, 17 in this case may contain file names, file type extensions, file creation date, last modified date, and file creator. The collection data 12, 16 may contain specific groupings of files into folders or sub-folder structures as defined by the file system 9, 10. Content 14 may be the actual files on the first networked computer which may be synchronized with content 18 on the second networked computer based on specific rules and policies such as compatibility of the file type with the second networked computer (so that the file content is only transferred if it is viewable, playable or in some way consumable on the second networked computer). Other policies may give preference to files more recently modified by the user on the first networked computer. In this implementation, a user may manage their desktop file system from a portable device by performing actions including creating or renaming folders (affecting collection data 16), changing their setting and preferences (affecting configuration data 15), or modifying file names (affecting metadata 17), all without necessarily having any content 14 of these files on the portable device. Upon synchronization of the portable device with the desktop computer, the user's modifications to 15, 16, 17 (application data 19) may be synchronized with 11, 12, 13 respectively (application data 20) so that all changes are reflected on the desktop computer.

Although these examples describe particular implementations for defining and synchronizing particular data layers, similar types of data layers may be defined for other types of data items such as enterprise CRM data.

### Defining a Common Schema

The present invention provides a common schema that enables optimal synchronization of data items among data management applications operating on various computer devices. The common schema may be defined such that there may be a mapping of some or all application data for the data items associated with each type of data management application included in the system of the present invention. Where the data management applications define at least some dissimilar application data types, the common schema may consist of more schema items than each of the data management application's application data types, such that there may be a mapping for most or all application data types of each data management applications in the common schema.

The present invention can define the common schema such that the number of common schema elements is an aggregation of the number of common application data types among the data management applications in the system plus the number of exclusive application data types of each of the applications. Therefore, there may be provided within the common schema a mapping for each possible application data type of each data management application. The common schema can be defined as a superset of the application data field types across the range of data management applications supported for synchronization such that a subset of the common schema is linked to or associated with the application data field types for each data management application.

The creation of the common schema could optionally be performed manually by a person by analyzing the application data types of each data management application or could be generated automatically or semi-automatically by interfacing with a data management application to discover the possible application data types of that data management application. The mapping may be stored in a computer readable format such as an XML document, database table or text file. The mapping process as described only needs to be performed once for each data management application and then stored within an application connector for each data management application to be leveraged over any instance of the data management application by distributing the corresponding application connector containing the defined mapping.

Changes in the schema of new versions of a data management application may require the common schema and data mappings to be updated from time to time. In this instance, there may be new additions of data fields to the common schema or changes to the data mappings of existing fields or both. If the mapping is stored in a particular computer readable format, only a file of that format need be distributed to existing application connectors so that they may support the newer version of the corresponding data management application. In addition, users or makers of new data management applications may be able to define mapping data to a published available common schema and make this mapping data available to other users in a file defined by the particular format.

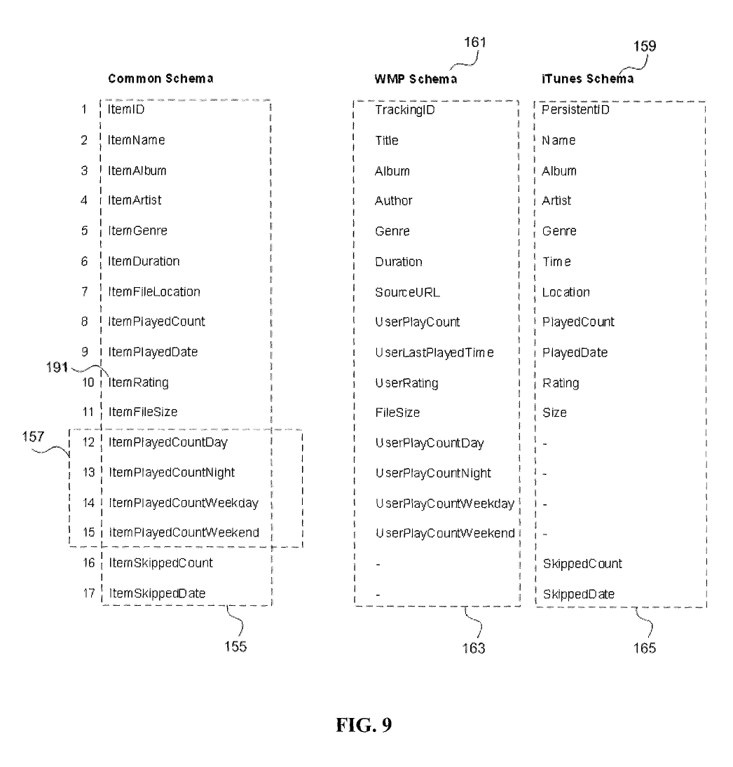

FIGS. 9, 11 and 13 illustrate detailed mappings for each layer of application data between two popular media management applications and a common schema. Although the example represents the mapping data in a table, it may also be represented in other formats such as an XML document, database table or text file as described above. In one implementation, an application connector may only store the mapping between a single data management application and a common schema. For example a digital music management utility connector may only store mapping data between the digital music management utility and the common schema and not any other data management applications. Additionally, the digital music management utility connector may store mapping data for different versions of the digital music management utility for compatibility reasons. In another implementation a broader music management utility connector may be defined that stores mapping data for a plurality of digital music management utilities if desired. In any case, the mapping data may be stored in a repository or other computer readable medium accessible by the application connector. The application connector may be operable to retrieve and apply said mapping data when converting data between the data management application schema and a common schema.

### Mapping Schemas for Metadata

FIG. 9 illustrates an example of schema mappings for a subset of metadata for data items between two particular data management applications. Each data item type, for example media including songs, pictures, or video, may have a defined set of metadata stored by each data management application.

Data management applications do not necessarily support a common set of metadata for data items. For example common schema 155 fields 157 twelve to fifteen may not exist in one data management application 159 but may exist in the other 161. The common schema 155 used by the synchronization utility could therefore be considered a superset of the schemas 163, 165 applicable to each data management. In this way the synchronization utility may synchronize metadata over one or more data management applications for those metadata of each data management application 159, 161 that are defined in the common schema 155.

The present invention can also enable adoption of metadata that does not exist in a particular data management application. For example, metadata for picture files is typically not as descriptive as metadata for audio files since a picture name and date may not adequately describe a picture in the way a song name might. As such, a data management application adapted to manage images may maintain thumbnails (smaller and potentially compressed versions of the images) as part of the metadata whereas another data management application may not support such an metadata. In this case, an application connector may augment the metadata by storing and accessing the thumbnail image as part of the metadata of the picture item.

The schema mapping may be used by application connectors to read metadata from each data management application and to convert the metadata to a common schema when sending metadata to the synchronization utility. The schema mapping may be also used when writing metadata back to each data management application for converting the common schema information back to the data management application schema to apply synchronized result sets generated by the synchronization utility.

### Mapping Schemas for Collection Data

The present invention also provides a common schema for collection data that enables optimal synchronization of collection data among data management applications. The common schema for collection data may be defined similarly to the common schema for metadata, except that collection data may be used to define this common schema for collection data. Furthermore, the techniques for initializing this common schema for collection data may also be similar to the initialization of the common schema for metadata.

The following discussion assumes the use of media management applications to describe playlists as the collection data. It would be apparent to a person skilled in the art that the collection data could be of another form in accordance with an applicable data management application.

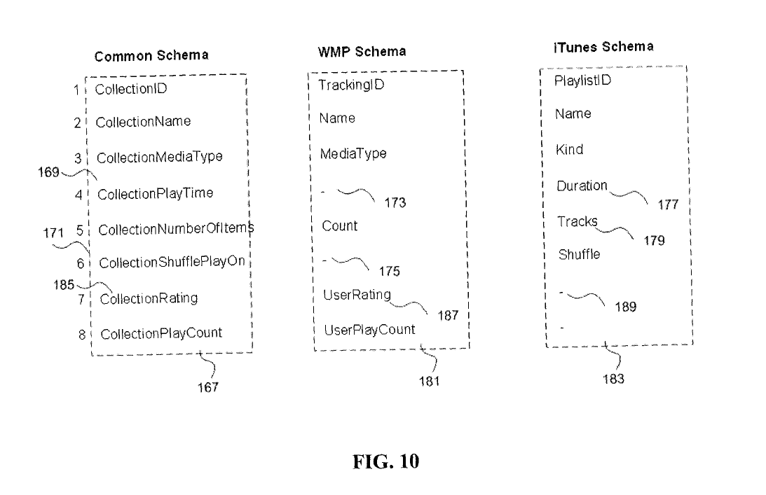

FIG. 10 illustrates an example of schema mappings for a subset of collection data pertaining to playlists between two particular media management applications. Playlists may be defined sets of collection data in each media management application. Not all media management applications necessarily support a common set of collection data. For example common schema 167 fields 169, 171 may not exist 173, 175 in one media management application but may exist 177, 179 in the other. The common schema 167 could again be a superset of the individual media management application schemas 181, 183.

The present invention can also enable adoption of types of collection data that do not exist in a particular data management application. For example common schema field 7 185 may exist in one schema 187 but not another 189. The field may be adapted by the application connector if it is advantageous or preferable to do so, and may be accomplished by mapping a field pertaining to the common schema 167 of the collection data to a field pertaining to an application schema 165 of content. For example, the collection rating 185 of the playlist at common field 7 may be applied to common schema 155 field 10 191 corresponding to the rating of content. In this way, a maximum amount of collection data may be synchronized to all data items even if the data management application does not support particular properties with respect to the collection data.

The schema mappings shown in FIG. 10 may be used by application connectors to read collection data from each data management application and convert these collection data to a common schema when sending collection data to the synchronization utility. The mapping may be used again when writing collection data to each data management application to convert from the common schema back to the data management application schema to apply result sets generated by the synchronization utility.

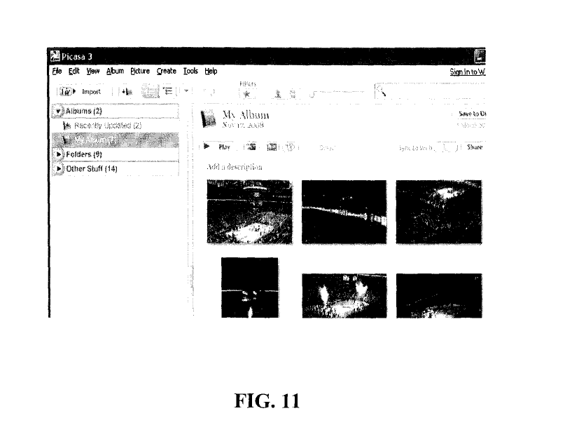

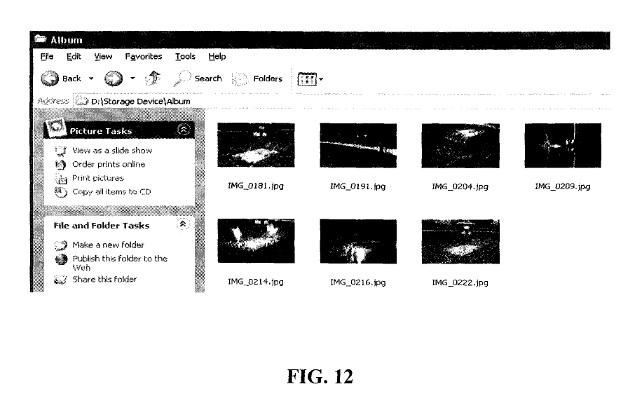

FIG. 11 illustrates a first example media management application wherein contents are images. The first media management application may support the creation of albums for pictures. FIG. 12 illustrates a second example media management application wherein contents are images. The second media management application may not support the creation of albums for pictures therefore may not contain collection data fields relating to albums. Therefore, when the synchronization utility processes synchronization of these two media management applications, the application connector may create collection data relating to the album, adding an album reference to the collection data for pictures belonging to the album. The conventional field mappings may not be sufficient since the second media management application does not have a collection data field corresponding to this information. Therefore, the present invention enables a substitute feature translation to create an adaptation to the collection data that is operable within the second media management application. For example, a file system folder may be created in the second media management application using, for example, APIs, and the images may be transferred to the newly created file system folder to mirror creation of the album as a folder on the file system. In this way, synchronization of collection data is possible even though one media management application does not support the particular collection data directly. In some instances no adaptation might exist, in which case that specific aspect of synchronization may not occur. For example if one data management application for pictures does not store picture captions, captions will not be synchronized during that synchronization session.

### Translating Configuration Data

The present invention also provides for methods to translate configuration data of data management applications as part of the adaptive layered synchronization of application data between data management applications. The translations may be enabled by a configuration data translation schema similar to the common schemas used for collection data and metadata, as described above. Initialization of the configuration data translation schema may also be similar to initialization of the common schemas used for collection data and metadata.

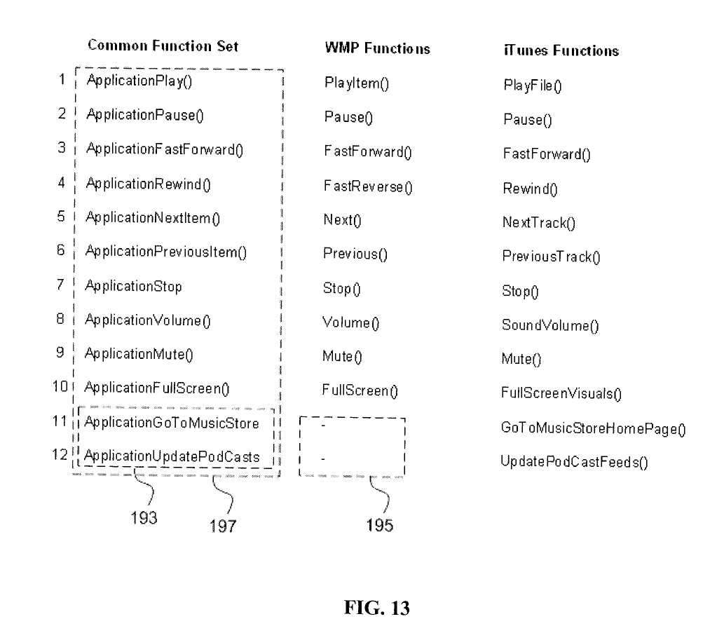

FIG. 13 illustrates a configuration data translation schema for translating certain configuration data of two particular data management applications. The configuration data embodied by configuration data shown in this example specifically relate to media playback however configuration data may include any other type of configuration data or settings of a data management application. Not all data management applications necessarily support all configuration data. For example configuration data 193 may not exist 195 in one of the data management applications. Again, the configuration data translation schema 197 may be a superset of the configuration data schemas of each data management application since the supported feature set is not the same over all data management applications.

Certain events may automatically trigger the synchronization utility to initiate a synchronization session resulting in the synchronization of the actual state of two data management applications using the configuration data translation schema. For example a desktop media management application may be synchronized with a media management application on an associated portable device such that the playback state of the currently playing song is synchronized between the two devices. In this manner a user that is listening to a song on their desktop, which could also be occurring within a playlist of songs, may continue listening to the song on the portable device from the exact point that they stopped on the desktop. Further, the position in the playlist from the desktop may be synchronized with that of the portable device enabling the user to seamlessly continue listening to the playlist from the portable device. In addition, user preferences such as volume setting may also be synchronized if it is advantageous or preferable to do so.

Alternatively, a user may be listening to a song within a playlist of songs on a portable device. When the portable device is within proximity of a desktop computer associated with the portable device, a trigger may result in the synchronization utility initiating a synchronization session in accordance with the present invention. The trigger may include a set of user actions or recognition of a portable device on the same wireless network as the desktop computer. In this manner, the playback may be paused on the portable device and the currently playing song, playback position and currently playing list may be synchronized to the associated media management application on the desktop computer so that the user can continue listening to music on the desktop computer exactly where they left off on their portable device.

As previously mentioned, the portable devices described above could be substituted by media players in an automobile. In still another embodiment, the synchronization session may take place in real-time between two media management applications while a connection exists instead of individual synchronization sessions being initiated by triggers. In this way, one media management application may be synchronized in real time to another media management application to emulate the media management application behaviour or configuration changes in real-time. In this manner, the present invention synchronizes not just content and attributes between data management applications, but also the settings and current state of data management applications as they relate to specific data items or collections of data items. This is especially beneficial to users that operate more than one data management application across various networked computers.

In some instances configuration data may be supported by one data management application but not by another. The configuration data translation schema presented provides the ability to adapt configuration data by defining substitute configuration data translations that may achieve a similar result in a similar manner as metadata and collection data. However, adaptations may not exist in all cases, in which case that specific aspect of synchronization may not occur.

### System Implementation

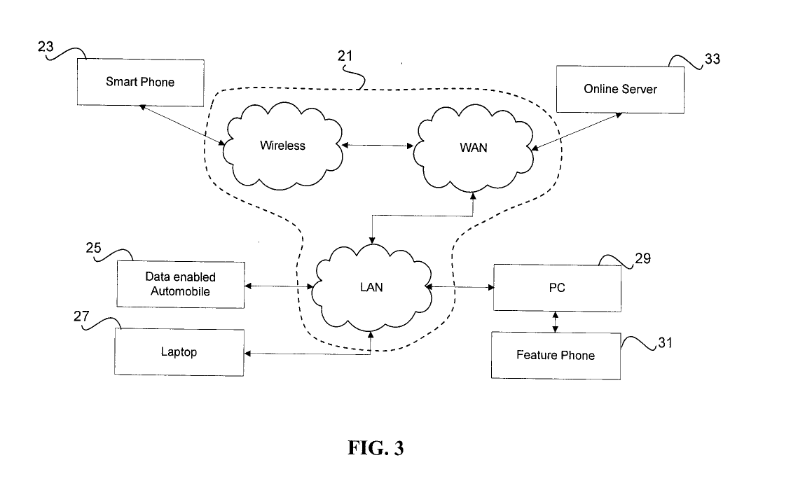

FIG. 3 illustrates a system implementation of the present invention for synchronizing one or more data layer over one or more networked computers 23, 25, 27, 29, 33 and one or more portable devices 31.

Each networked computer 23, 25, 27, 29, 33 may be linked to all data items, regardless of whether each networked computer 23, 25, 27, 29, 33 has all or a differing subset of content associated with the data items. In accordance with the present invention as described herein, one or more data layer of the data items may be synchronized, using the adaptive data layer synchronization model of the present invention, between all networked computers 23, 25, 27, 29, 33 connected either directly or indirectly to a network 21.

The present invention enables adaptive data layer synchronization to take place at an application level rather than a networked computer level. The applications are the data management applications. If the user makes one or more changes to a data item in a particular data management application on a first networked computer the changes are synchronized with one or more of the data management applications of the user's other networked computers. The user can therefore use the data management application of a second networked computer to, for example, continue tasks that were in progress on the first networked computer even if the data management applications are different. This allows the user to seamlessly manage and consume data items from any number of different networked computers.

Each of the networked computers (or clients) 23, 25, 27, 29, 33 may be linked to data management applications using application connectors making outbound connections either directly or by proxy. The networked computers 23, 25, 27, 29, 33 may communicate with one another directly or indirectly. It should be noted that in another implementation, each networked computer may not be capable of communicating with any other networked computer but rather only to the respective server to which it is connected.

This system implementation enables networked computers 23, 25, 27, 29, 33 to communicate with any other networked computers 23, 25, 27, 29, 33 through the transport connections between servers. This enables networked computers 23, 25, 27, 29, 33, regardless of the server to which they are connected, to send and receive data over the network 21.

Furthermore, one or more of the data management applications can operate on a networked computer or can be hosted as an Internet service.

The networked computers 23, 25, 27, 29, 33 may include both networked desktop computers or servers linked to the network, whether by wired or wireless networking means. Alternatively, one or more of the data management applications can operate on portable devices 31 that may or may not have a network connection. The portable device could be, for example, MP3 players or mobile phones equipped with media management applications for consuming and/or managing a media collection.

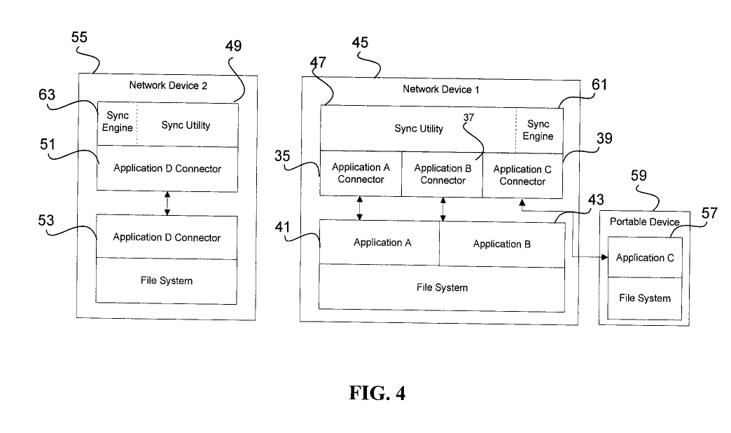

FIG. 4 illustrates an architecture diagram of a system of the present invention. A synchronization system comprised of a plurality of networked computers permits the synchronization of data items including application data and content between data management applications on the networked computers using various wired and/or wireless communication links.

The present invention enables both local synchronization and remote synchronization. Local synchronization comprises synchronization between data management applications present on a single networked computer, whereas remote synchronization comprises synchronization between data management applications on more than one networked computer, requiring synchronization utilities to communicate to synchronize data between the applications.

The synchronization utility 47, application A connector 35, application B connector 37, application C connector 39, application A 41 and application B 43 may operate on a first networked computer 45. Another synchronization utility 49, application D connector 51, and application D 53 may operate on a second networked computer 55. Application C 57 may operate on a portable device 59. As previously mentioned, any or all of these components could be implemented on a plurality of networked computers.

In one example, application A 41 may be used for managing music, application B 43 may be used for managing photos and applications C 57 and D 53 may be universal media management applications for managing both photos and music.

Application A 41, application B 43, application C 57 and application D 53 should at least be capable of receiving and storing data items and may further be capable of transferring data items. Still further, these applications may also process, display, present, modify, play or otherwise consume content or attributes associated with the data items.

An application connector is a software or process that can access or modify data items and associated attributes from a data management application running on a networked computer 55, 45 or 59. Typically, a data management application provides an interface, for example an Application Programming Interface (API), to access data from the data management application. Since API specifications, capabilities and usage can differ between data management applications, an application connector as provided by the present invention enables reading from and writing of data to a specific data management application or group of similar data management applications (for example multiple versions of the same application).

An application connector may be implemented by the synchronization utility 47 and 49 or preferably separated into distinct modules that may be linked to the synchronization utility 47 and 49 for each application they communicate with. An application connector is used by the synchronization utility to gather content 3 and application data for the data collection within a data management utility and modify the application data from time to time. An application connector may take as input the fields required to be gathered from a data management application and returns those field values for all data items within the data management application.

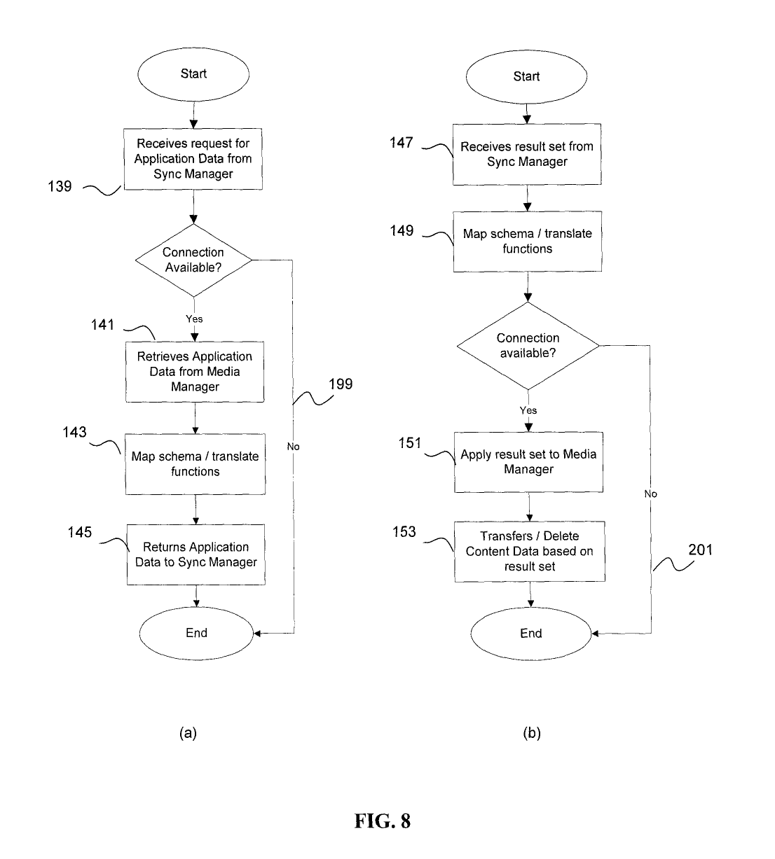

Operation of an application connector is illustrated in FIG. 8. Application A connector 35, application B connector 37, application C connector 39, and application D connector 51 interface with application A 41, application B 43, application C 57, and application D 53, respectively, to read and write data from and to the applications 41, 43, 57, 53. Since application A connector 35 and application B connector 37 may reside on the first networked computer 45 as application A 41 and application B 43, they may communicate with each other directly using an accessible interface such as an API as supported by application A 41 and application B 43. The same may apply for application D connector 51 and application D 53. Since a data management application and a corresponding application connector may also operate on separate network devices, application C connector 39 may communicate with application C 57 in a similar manner as described above, except over a wired or wireless connection, as available, since application C 57 operates on a different networked device. As explained above, the application connectors may be used by a synchronization utility to synchronize data over a plurality of data management applications, operating on the same or different network device, with different interfaces, features and capabilities.

Synchronization utility 47 may communicate with application A 41, application B 43, and application C 57 via application A connector 35, application B connector 37, and application C connector 39 respectively, to access and modify all data items within each data management application. Synchronization utility 49 may communicate with application D 53 via application D connector 51. Synchronization utilities 47, 49 may contain synchronization engines 61, 63, responsible for performing adaptive layered two-way synchronization between local or remote applications. The synchronization of individual data items or collections of data items may be managed by each application. Synchronization utilities 47, 49 may communicate with each other over a wired or wireless connection.

In accordance with the above example, application C 57 (which may for example reference both music and photo media items) on the portable device may synchronize with both application A 41 (which may reference only music media items) and application B 43 (which may reference only photo media items). This synchronization session is local to the first network computer 45 since synchronization utility 47 operates on and is able to access all applications 41, 43 and 47 via application connectors 35, 37 and 39 that operate on the first networked computer 45. Additionally, application D 53 (which may reference music and photos) on a second networked computer 55 may synchronize with application A 41 (music) and application B 43 (photos) on the first network computer 45. This is a remote synchronization session. In all cases, the synchronization utility manages synchronization. In each of these instances, the synchronization utilities facilitate the exchange of data, in accordance with the adaptive data layer synchronization model of the present invention, between applications used on each networked computer to manage media items.

In an alternate implementation, the portable device may also provide an application connector and/or a synchronization utility similar to that on the networked computers. In yet another alternative implementation, a networked computer may include only a synchronization, residing on a server network device and may interface with application connectors on a plurality of other networked computers to perform synchronization over a plurality of applications over the plurality of networked computers.

In another example, applications A 41 and B 43 illustrated in FIG. 4 may represent particular enterprise CRM application modules on a server, such as the first network computer 45, and portable device 59 operates application C 57, a compatible mobile version of the enterprise CRM application. The synchronization model presented in FIG. 2 and the architecture presented in FIG. 4 enable synchronization of independent layers of CRM enterprise data between a mobile device and server applications using the adaptive data layer synchronization model of the present invention.

In yet another example Application C 57 may represent an online hosted media management application such as Yahoo! Flickr™ or Facebook™ for managing content online that operates on a server 33 in FIG. 2. Application C connector 39 may operate on network device 45 such as a PC 29 in FIG. 2 and interface with Application C over data communication network 21. In this way, adaptive data layer synchronization is possible with data management utilities that operate across data communication networks on remote servers.

It should be readily apparent to those skilled in the art that the synchronization system may interface, analyze and synchronize data from a plurality of applications on a plurality of network computers by interfacing with corresponding application connectors, even though only a limited number are illustrated in FIG. 4.

### Synchronization

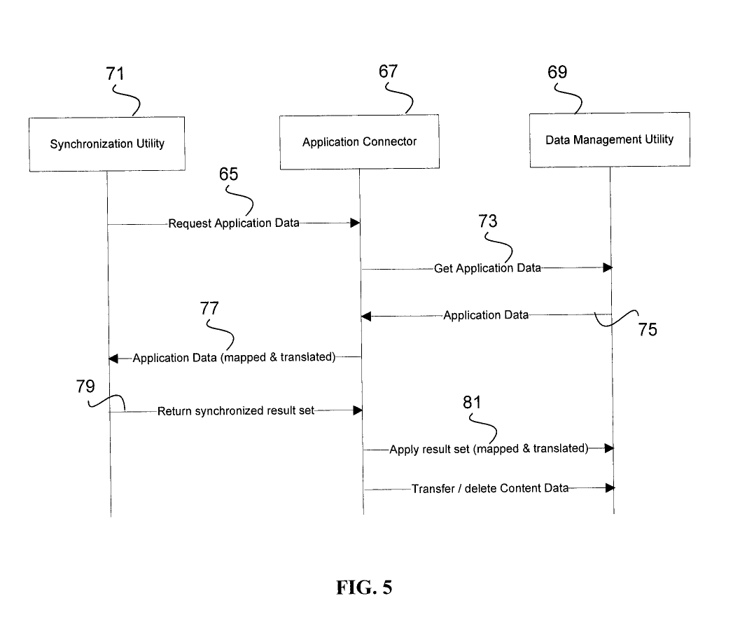

FIG. 5 illustrates the process of synchronization in accordance with the present invention showing the sequence of events between a synchronization utility 71, application connector 67 and data management application 69. FIG. 5 illustrates such a process in relation to one data management application, but it would be clear to a person skilled in the art that a similar process could be carried out for each data management application present in the system. The synchronization session may, for example, be performed by an intermediary server and/or one or more of the networked computers on which each data management application operates. The synchronization session may be active or passive. The synchronization utility 71 may initiate the synchronization process by a triggered event including availability of a wired or wireless connection or a user or application process. When synchronization session starts, a request 65 may be made to each application connector 67, associated with each data management application 69 to retrieve 73 the latest application data from each data management application 69. The communication channel by which the request 73 is made and the applications' attributes are received or retrieved 75 can vary, but the channel may be a wired or wireless connection. Each application connector 67 may receive or retrieve 75 application data from the respective data management application 69.

Application connector 67 may then map and translate 77 the application data to the common schema for sending the application data to synchronization utility 71. Synchronization utility 71 may analyse the received application data and synchronize the application data, as explained more fully below, provided by the application connector. It should be noted that synchronization of data may be agnostic to the type of data management application since synchronization may take place in accordance with the common schema.

Synchronization utility 71 may return a synchronization result set 79 to each application connector 67 to be applied 81 by the application connector 67 to the respective data management application 69. The synchronization result set may contain information that enables the application data and content to be synchronized between each data management application between the data layers requested.

### Synchronization Utility

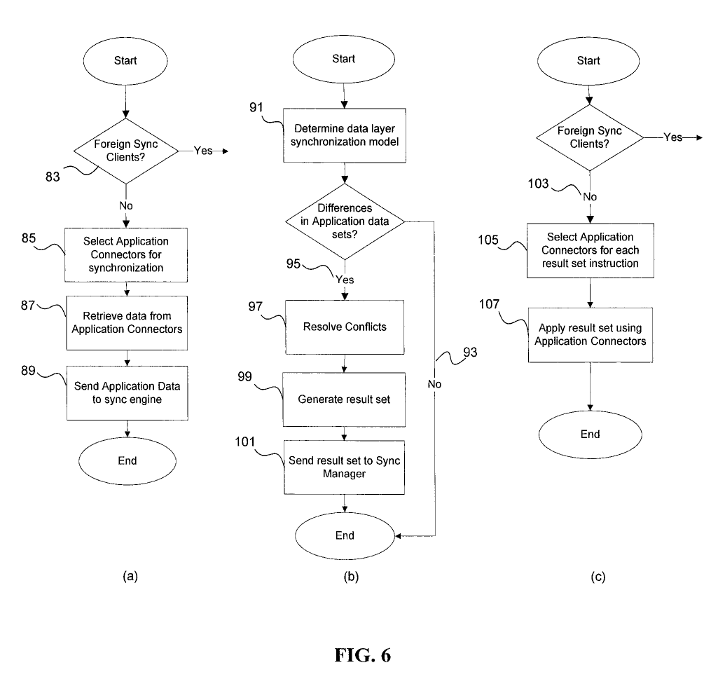

FIG. 6 illustrates flow diagrams relating to synchronization processes in accordance with the present invention. FIG. 6a illustrates the start of a synchronization process performed by a synchronization utility. FIG. 6b illustrates operation of the synchronization engine, previously illustrated in FIG. 4, within the synchronization utility. FIG. 6c illustrates the end of a synchronization process.

For example, a user may initiate synchronization of application C 57 on their portable device 59 with application A 41 and application B 43 on a first networked computer 45. The synchronization process may be started by synchronization utility 47. The synchronization process can, for example, be performed by an intermediary server and/or one or more of the networked computers on which each data management application operates. The synchronization utility 47 may initiate the synchronization process by a triggered event including availability of a wired or wireless connection or a user or application process. If the synchronization includes remote clients 83, which may be applications not accessible via application connectors on the present computing device, the present aspect of the synchronization process may be aborted. Otherwise since application A connector 35, application B connector 37 and application C connector 39 may all be accessible by the synchronization utility 47, there may be no remote clients such as the second networked computer 55, in which case the synchronization process proceeds.

The synchronization utility 47 may then determine the application connectors it must use for synchronization of applications 85. In accordance with the example previously provided, application data from application A 41 (music) and application B 43 (photos) may need to be synchronized with application C 57 (music and photos). This need may be explicitly stored (for example, using a lookup table for listing applications to be synchronized or provided through user input) or implicitly ascertained by analysis of the data types within each application (for example, where applications having the same data types would be synchronized). The application data may be retrieved 87 from each of application A 41, application B 43 and application C 57 via application A connector 35, application B connector 37 and application C connector 39, respectively. In this case, application C connector 39 may retrieve application data from application C 57 only if there is a wired or wireless connection between the first networked computer 45 and portable device 59 on which each operates. If there is no connection available, synchronization may have to be delayed or aborted. Application data for application A 41 and application B 43 may be aggregated into one application data set in accordance with the common schema and sent 89 to synchronization engine 61 with application data for application C 57.

The synchronization engine 61 may be initialized upon receiving two or more application data sets for synchronization. As illustrated in FIG. 6b, the type of synchronization data model may first be determined 91. The synchronization data model could be, for example, content data only, application data only, one or more layers of application data or a combination thereof. The determination 91 may be based on previously defined information for each application or information provided by the application connectors to the synchronization utility 47. The synchronization model may define independent data layers as illustrated in FIG. 2, as well as all or a subset of data items, including their corresponding content, to be synchronized. The application data set to be analyzed may be defined based on the synchronization model used. In accordance with the example previously provided, the preferred synchronization model may be to synchronize all application data and only some content as requested by the user or based on previously defined rules and policies, since application C operates on portable device 59 which may have relatively less storage capacity compared to the first networked computer 45.

If there are no differences between the defined application data sets 93 of the data management applications the process may be aborted, since no synchronization is necessary. If there are differences between the defined application data sets 95, any conflicts in the application data sets may be resolved 97 using any of several schemes for defining a winner in conflict situations, which are known to those skilled in the art.

During the synchronization process, application data need not necessarily be synchronized between the applications since the application connectors may be responsible for reading and writing attributes from and to the data management applications and managing application-specific details. Optionally, a synchronization result set may be generated 99 that, when applied to each data management application using the application connectors, may result in all data management applications being in a synchronized state. The synchronization result set may be generated based on the differences (i.e. delta) that exist between each data management application after the previously executed synchronization process, and could correspond to any additions, modifications, deletions, user actions and configuration changes performed on one data management application. The synchronization result set may be sent 101 to the synchronization utility 47. The synchronization result set could alternatively contain the entire application data set rather than simply the differences therein.

The synchronization utility 47 then receives the synchronization result set for each data management application from the synchronization engine process described above. As illustrated in FIG. 6c, if it is determined that there are no remote clients 103, application connectors 35, 37 and 39 may be selected 105 corresponding to the synchronization result set returned from the synchronization engine 61. The synchronization result set may be applied 107 to each data management application to complete the synchronization process.

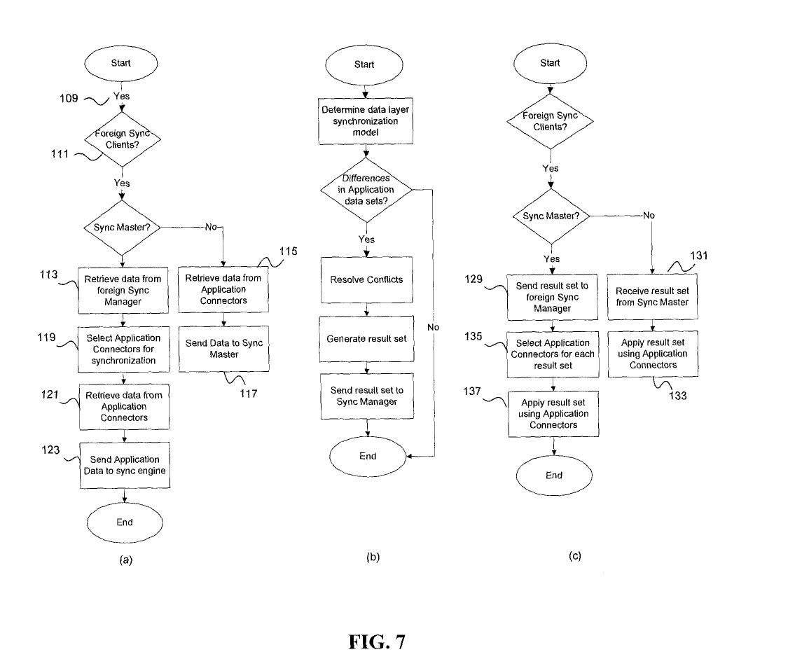

FIG. 7 illustrates the synchronization process of the present invention, wherein synchronization occurs between networked computers with data management applications and includes remotes clients. FIG. 7a illustrates synchronization occurring between an application on one device and one or more applications on other devices. FIG. 7b illustrates the operation of a synchronization engine process. FIG. 7c illustrates the last part of the synchronization process.

FIG. 7a illustrates synchronization occurring between a data management application on one device and one or more data management applications on other devices. For example, synchronization may occur between application D 53 on the second networked computer 55 with application A 41 and application B 43 on the first networked computer 45 as previously illustrated in FIG. 6. Following the above example, this process may include the synchronization of remote clients. If the synchronization request includes remote clients 109, which may include data management applications not accessible via application connectors on the present networked computer, the synchronization process may then determine 111 whether the current synchronization utility 49 is the synchronization master. A limitation may exist to resolve conflicts, whereby only one synchronization utility, typically being typically the synchronization utility that initiates the synchronization session, may be a synchronization master. For example, using FIG. 4 to illustrate this point, synchronization utility 49 may be the synchronization master, retrieving data 113 from application A 41 and application B 43 via synchronization utility 47. Synchronization utility 47 may also append useful data to the application data set it sends such as a unique identifier for the networked computer on which the synchronization utility operates to assist the synchronization master in sending a synchronization result set back to synchronization utility 47. For example, the unique identifier could be an IP address, MAC address or similar uniquely identifying information.

Correspondingly, synchronization utility 47 determines that it is not the synchronization master, and may then proceed to retrieve the synchronization result set 115 from application A 41 and application B 43 and send the application data to the synchronization master 117, which in this example is synchronization utility 49.

The synchronization utility then determines the application connectors it must use 119 for accessing and modifying data from each data management application. This determination may be explicitly stored (for example, using a lookup table for listing applications to be synchronized or provided through user input) or implicitly ascertained by analysis of the data types within each application (for example, where applications having the same data types would be synchronized). In the current example, application data from applications A 41 (music) and application B 43 (photos) may need to be synchronized with application data from application D 53 (music and photos). Synchronization utility 47 may select application D 53 connector and retrieve 121 application data from application D 53. Since it may have already received application data from application A 41 and application B 43 in an aggregate manner from the synchronization utility 47, the synchronization utility 49 may send 123 both application data sets to the synchronization engine 63.

FIG. 7b illustrates the operation of the synchronization engine process. The process may be similar to that illustrated in FIG. 6b and described above. Optionally, a different synchronization model may be selected. In accordance with the above example, since both networked computers 45, 55 may not have any storage capacity constraints the preferred model may be to synchronize all application data and all content.

FIG. 7c illustrates the last part of the synchronization process. The synchronization utility 49 may receive the synchronization result set for each application from the synchronization engine process. If there are 125 remote clients and the current process is the synchronization master 127, the synchronization result set for application A 41 and application B 43 may be sent 129 to a remote synchronization utility 47 from which the application data were received. In one implementation, each synchronization utility may append a unique identifier to the application data set it sends to the synchronization master 127 and synchronization master 127 may use that information to determine how to send synchronization result sets, if any, back to each synchronization utility.

In a parallel process corresponding to the remote synchronization utility 47 that is not the synchronization master, the remote synchronization utility 47 may receive 131 the synchronization result sets and apply 133 the synchronization result set received to application A 41 and application B 43 using application A connector 35 and application B connector 37, respectively.

Meanwhile, a local synchronization process may proceed to select 135 application D connector 51 to apply 137 the synchronization result set returned from the synchronization engine 63.

### Application Connectors

Application connectors may be used by the synchronization utility to access and write or otherwise modify application data from and to data management utilities. Application connectors may reside on the same networked computer as a data management application such as 35 and 41 (see FIG. 4) or on separate networked computer such as 39 and 57 (see FIG. 4). An application connector may have a one-to-one relationship with a data management application (see FIG. 4) or may have a one-to-many relationship with data management applications if the application connector is able to interface with a plurality of data management applications. For example, this may be the case if there are multiple instances of the same type of data management application on a network device that are to be synchronized.

FIG. 8 illustrates a method of mapping and translating application data (including configuration data) in accordance with the present invention.

FIG. 8a illustrates the operation of an application connector to retrieve application data from a data management application. The application connector may receive a request 139 for application data and attempt to connect to its corresponding data management application via an interface such as an API. If the application connector is able to connect, application connector may proceed to retrieve 141 the application data. An application connector may map the application data to a common schema which may require translation of the corresponding configuration data 143. The means for translation is described in further detail below. The application data may be returned 145 to the synchronization utility to complete the synchronization process.

Application connector may be unable to connect to data management application 199 for a number of reasons including a lack of availability to connect to a remote data management application or a busy or unavailable local data management application. If application connector is unable to connect 199, it may either delay or abort processing returning an error message to the triggering event or configuration data.

FIG. 8b illustrates a method of updating application data in a data management application. An application connector may receive a synchronization result set 147 from a synchronization utility and attempt to connect to the corresponding data management application. If application connector is able to connect it may take steps to apply the synchronization result set to the corresponding data management application. The synchronization result set may be mapped to the particular schema applicable to the data management application and configuration data may be translated 149 so that they can be applied 151 towards the data management application. The result set may also contain information regarding the additions, modifications or deletions of application data and content. Content may be transferred or deleted 153 and may be optimized for transfer over a wired or wireless network by using data compression. Additionally, application connectors may optimize content for transfer over a wired or wireless network, which may include, for the media example, compression, adjustment of video frame rates or resolution, transcoding of content, etc.

Application connector may be unable to connect to data management application 201 for the same reasons described in 201. If application connector is unable to connect 201, it may either delay or abort the processing returning an error message to the caller process or configuration data. Optionally, it may store the synchronization result set until it is able to connect to the data management application at which time it may apply the synchronization result set.

A completed synchronization session may also trigger a further set of instructions to enable application connectors or data management applications to perform other actions. For example completion of synchronization could result in a data management application downloading additional content from the Internet, such as album artwork relating to a media item.

### Further Implementations

FIGS. 9, 11 and 13 provide examples of mapping metadata, collection data and translating configuration data between media management applications and a common schema. Similar mappings may be created in other types of data management applications such as enterprise CRM application components. Mapping data may similarly be generated for each CRM component and bundled in application connectors for each component as described in the media management applications of the example above. This process may allow two enterprise CRM applications from different vendors to interface and synchronize data as well as synchronize data items with various other data management applications that may make use of CRM data, including data management applications on mobile phones.

Although the common schemas in FIGS. 9, 11 and 13 contain fields or configuration data mappings between various data management applications, the common schema may be extended to contain further useful information when the data is passed to and received from a synchronization utility. For example a synchronization utility may interface with a plurality of data management applications to aggregate and disseminate application data. In this case each application connector may append a unique identifier corresponding to the application connector or the data management application to the common schema to help the synchronization utility aggregate from and disseminate application data to each application connector. Alternatively, the synchronization utility may be able to perform configuration data translation as it retrieves application data from each application connector.

One of the results of the synchronization utility provided herein is that data management applications may use the synchronization utility to remotely configure and control one another. The configuration and control may relate to changes in the data items or attributes stored in each data management application. The configuration and control may also relate to the state of the data management application such as, in the case of media, the currently playing track, the currently viewed photo or other renderings of data, as well other user preferences and settings such as volume controls. The configuration and control may also lead data management applications to perform actions such as downloading new content or affecting the underlying hardware mediums such as adding content to memory stores or removing content from memory stores to free space.

Furthermore, although the above described implementations of the present invention may relate to particular system, network, and software architectures, it should be understood that the invention is not so limited. For example, the synchronization utilities may be deployed on one or more remote networked computers. The application connectors may also be deployed on one or more of the remote networked computers, or may be executed locally on devices hosting data management applications in such a way as to interface with the remote synchronization utilities. In a yet further implementation, one synchronization utility may be provided to associate with application connectors corresponding to each networked computer or portable device. Many further architectures exist that provide configuration dataality in accordance with the present invention.

1. A system for synchronizing one or more data items between a plurality of data management applications, the system comprising:
(a) a plurality of data management applications, implementable to a plurality of interconnectable computers, each data management application being associated with or operable to access one or more content wherein associated with the one or more content is one or more attributes, wherein at least one data management application manages the one or more attributes differently than at least one other data management application;
(b) one or more application connectors, each of the plurality of data management applications being linked to an application connector or including an application connector, each application connector being operable to (i) translate one or more data layers of the one or more attributes to conform to a common schema thereby defining common schema information, and (ii) enable the translation of the common schema information to provide one or more updated data layers of the one or more attributes conforming to at least one of the data management applications; and
(c) at least one synchronization utility linked to the one or more application connectors, operable to synchronize one or more layer of content or one or more attributes, including one or more specific data layers of such content or one or more attributes, between two or more data management applications.

2. The system of claim 1, wherein the synchronization utility, having received the common schema information from one or more of the application connectors, is further operable to merge the one or more instances of the received common schema information prior to disseminating the common schema information to the associated application connectors.

3. The system of claim 1, wherein the attributes include application data and configuration data.

4. The system of claim 3, wherein the application data includes metadata and collection data.

5. The system of claim 4, wherein at least four layers are provided, one for each of content, metadata, collection data and configuration data.

6. The system of claim 5, wherein the synchronization utility synchronizes only those layers for which updates have been made in at least one of the data management applications.

7. The system of claim 6, wherein the synchronization utility synchronizes only those particular content, application data and configuration data for which updates have been made.

8. A system for synchronizing one or more data items between a plurality of data management applications, the system comprising a synchronization utility, implemented to a computer so as to enable synchronization of one or more of content, application data and configuration data, as between the plurality of data management applications, the plurality of data management applications being implemented to one or more interconnectable computers;
wherein each data management application is associated with or operable to access the one or more content, wherein associated with the one or more content is application data, wherein at least one data management application manages the application data and configuration data differently than at least one other data management application;
wherein the synchronization means is operable to enable synchronization of one or more of content, application data and configuration data between two or more data management applications by:
(1) translating or facilitating the translation of one or more of content, application data or configuration data to conform to a common schema thereby defining common schema information for one or more data management applications; and
(2) translating or facilitating the translation of common schema information to updated content or application data for one or more other data management applications so as to initiate updates thereof for the at least one other data management application.

9. The system of claim 8 wherein the synchronization means is operable to enable synchronization of selective layers of one or more of content, application data and configuration data.

10. The system of claim 9, wherein the updates correspond to additions, deletions and modifications of one or more layers.

11. The system of claim 9, wherein the synchronization means synchronizes only those layers for which updates have been made in at least one of the data management applications.

12. The system of claim 11, wherein the synchronization means synchronizes only those particular content, application data and configuration data for which updates have been made.

13. A computer-implementable method for synchronizing one or more data items, the method comprising:
in relation to at least one data management application and at least one other data management application, wherein each data management application is associated with or operable to access one or more of content, application data and configuration data, wherein at least one data management application manages one or more of application data and configuration data differently from at least one other data management application;
synchronizing one or more of content, application data and configuration data between the at least one data management application and the at least one other data management application by:
(1) translating, or facilitating the translation, by one or more computer processors, the one or more of content, application data and configuration data to conform to a common schema thereby defining common schema information;
(2) translating or facilitating the translation of common schema information to one or more of updated content, application data and configuration data for the other data management applications so as to initiate updates thereof for the at least one other data management application.

14. The method of claim 13 wherein the synchronization means is operable to enable synchronization of selective layers of one or more of content, application data and configuration data.

15. The method of claim 13, wherein the updates correspond to additions, deletions and modifications of one or more of application data and configuration data.

16. The method of claim 13, wherein the application data includes metadata and collection data.

17. The method of claim 16, wherein at least four layers are provided, one for each of content, metadata, collection data and configuration data.

18. The method of claim 17, wherein the synchronization means synchronizes only those layers for which updates have been made in at least one of the data management applications.

19. The method of claim 18, wherein the synchronization means synchronizes only those particular content, application data and configuration data for which updates have been made.
